(19) United States
(12) Patent Application Publication
(10) Pub. No.: US 2022/0141323 A1
(43) Pub. Date: May 5, 2022

(54) MOBILE PHONE

(71) Applicants: HONGFUJIN PRECISION ELECTRONICS (ZHENGZHOU) CO., LTD., Zhengzhou (CN); HON HAI PRECISION INDUSTRY CO., LTD., New Taipei (TW)

(72) Inventor: BO-DUO YUAN, Shenzhen (CN)

(21) Appl. No.: 17/165,348

(22) Filed: Feb. 2, 2021

(30) Foreign Application Priority Data
Oct. 30, 2020 (CN) 202022464095.6

(51) Int. Cl. H04M 1/02

(52) U.S. Cl. CPC H04M 1/026

(57) ABSTRACT

A mobile phone includes a lower housing, an upper housing, a speaker unit, a small plate, and a first sealing member. A first receiving cavity is cooperatively formed between the lower housing and the upper housing. The speaker unit is arranged in the first receiving cavity. The small plate is arranged in the first receiving cavity and electrically coupled to the speaker unit. The first sealing member surrounds an inner wall of the first receiving cavity and seals a connection between the upper housing and the lower housing. The first receiving cavity serves as a sound cavity for the speaker unit.

### FIELD

The subject matter herein generally relates to mobile phones, and more particularly to a mobile phone having an improved sound cavity design.

### BACKGROUND

To ensure the excellent sound performance of mobile phones, existing mobile phones generally use independent speaker boxes, but the speaker box itself will take up space in the mobile phone, which lowers the sound performance. In addition, a lock screw assembly of the speaker box is cumbersome, the acoustic yield is low, and material and assembly manufacturing costs are high.

### BRIEF DESCRIPTION OF THE DRAWINGS

Implementations of the present disclosure will now be described, by way of embodiments, with reference to the attached figures.

FIG. 1 is a schematic diagram of a mobile phone according to an embodiment of the present disclosure.

FIG. 2 is a partial exploded schematic diagram of the mobile phone in FIG. 1.

FIG. 3 is an exploded schematic diagram of a sound cavity of the mobile phone in FIG. 2.

FIG. 4 is an exploded schematic diagram of the sound cavity in FIG. 2.

FIG. 5 is a cross-sectional diagram taken along line V-V in FIG. 1.

FIG. 6 is a schematic diagram of a lower housing of the mobile phone.

### DETAILED DESCRIPTION

It will be appreciated that for simplicity and clarity of illustration, where appropriate, reference numerals have been repeated among the different figures to indicate corresponding or analogous elements. Additionally, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising” means “including, but not necessarily limited to”; it specifically indicates open-ended inclusion or membership in a so-described combination, group, series, and the like.

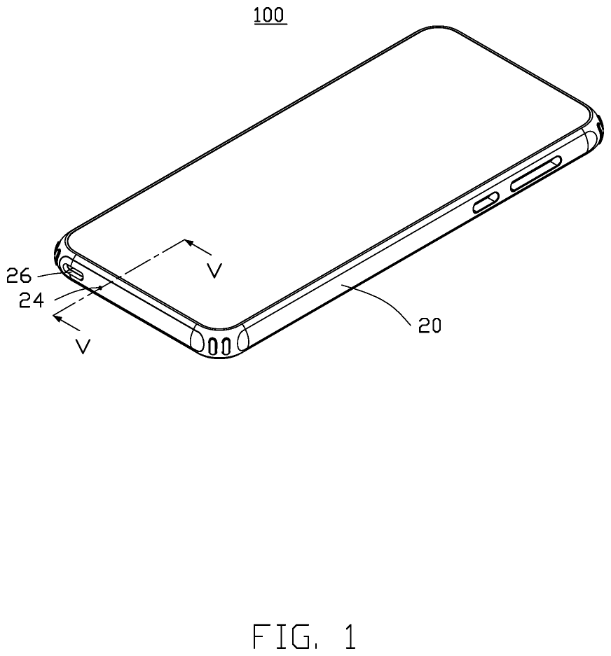

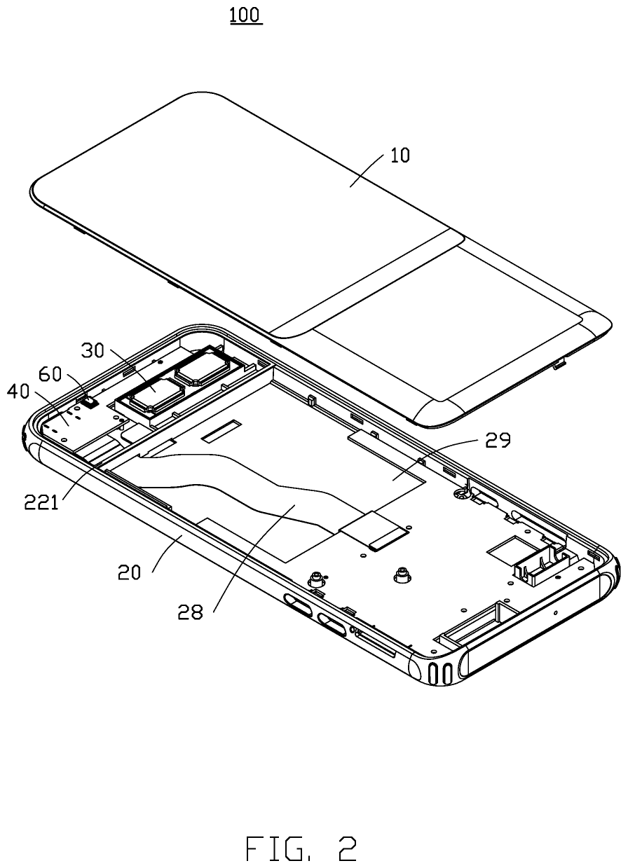

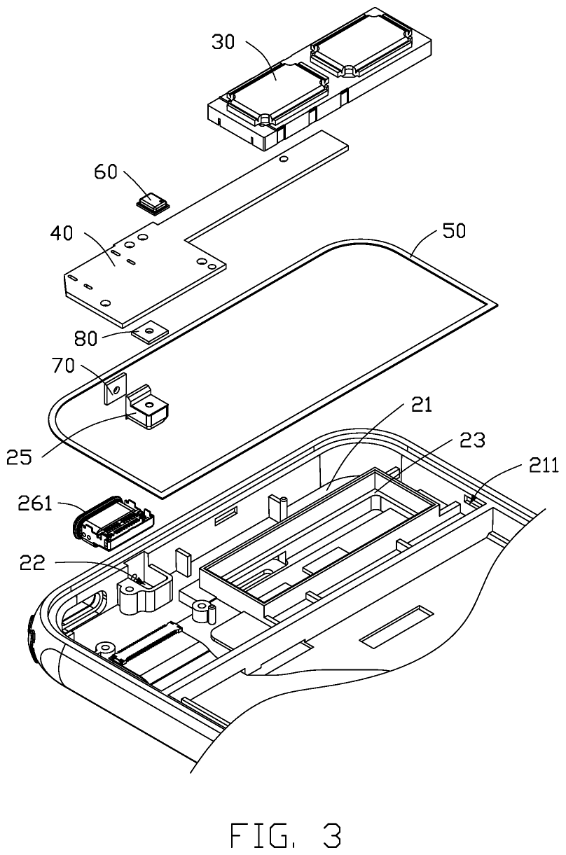

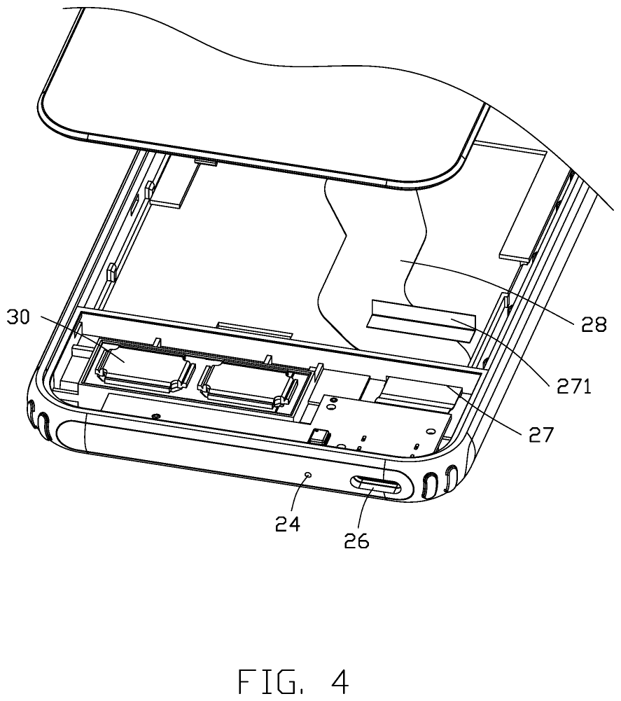

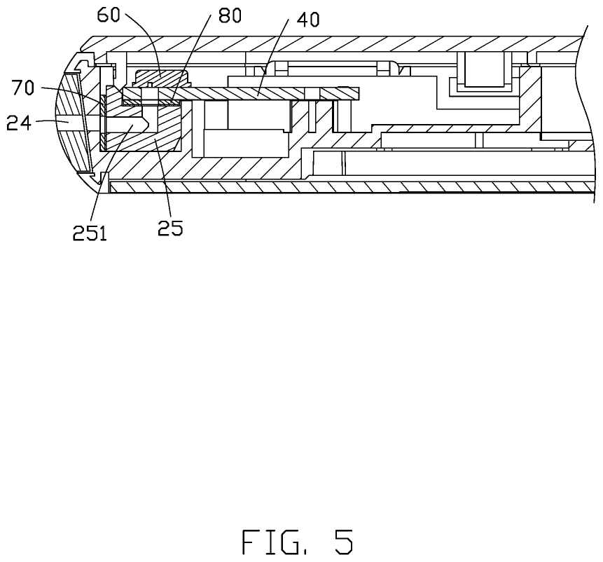

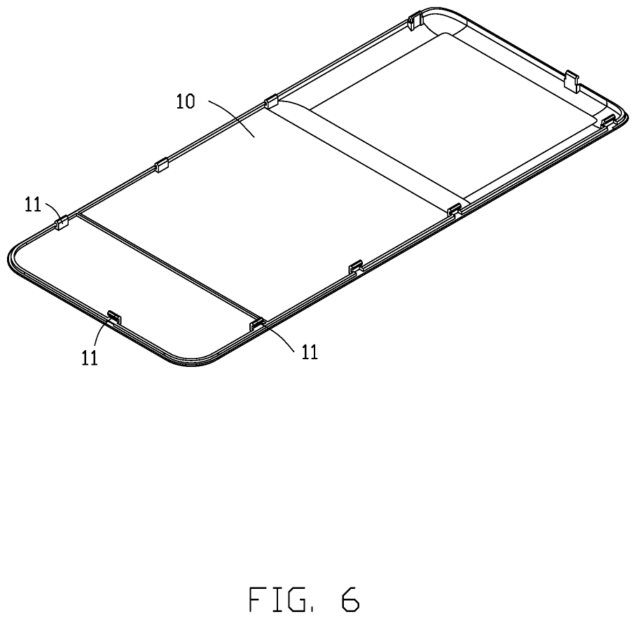

Referring to FIGS. 1-6, a mobile phone 100 includes a lower housing 10, an upper housing 20, a speaker unit 30, a small plate 40, and a first sealing member 50. A first receiving cavity 21 is cooperatively formed between the lower housing 10 and the upper housing 20. The speaker unit 30 is arranged in the first receiving cavity 21. The small plate 40 is arranged in the first receiving cavity 21 and electrically coupled to the speaker unit 30. The first sealing member 50 surrounds an inner wall of the first receiving cavity 21 and is used to seal the first receiving cavity 21 when the upper housing 20 is coupled to the lower housing 10. In one embodiment, the first receiving cavity 21 serves as a sound cavity for the speaker unit 30.

Since the first receiving cavity 21 is sealed by the first sealing member 50 to serve as a sound cavity for the speaker unit 30, the speaker unit 30 does not require additional structures to form a sound cavity, thereby increasing a volume of the sound cavity and improving a sound effect of the speaker unit 30. In addition, no additional structure is required, which simplifies an assembly process and improves production efficiency and yield of the mobile phone 100.

In one embodiment, the first sealing member 50 may be a sealing foam.

In one embodiment, at least three first connecting portions 211 are provided on an inner wall of the upper housing 20, and the lower housing 10 is provided with a corresponding number of second connection portions 11. The first connecting portions 211 are clamped with the corresponding second connecting portions 11 when the upper housing 20 is coupled to the lower housing 10.

The first sealing member 50 improves an airtightness of the sound cavity and the sound effect of the speaker unit 30. The first connecting portions 211 and the second connecting portions 11 are snap-connected, which improves a stability of the connection between the upper housing 20 and the lower housing 10.

In one embodiment, the upper housing 20 is provided with a stepped portion 23. The speaker unit 30 is arranged on the stepped portion 23 and can be fixedly coupled to the upper housing 20.

In one embodiment, the speaker unit 30 and the upper housing 20 are bonded together by glue.

In other embodiments, the speaker unit 30 and the upper housing 20 may be bonded together by other adhesives.

In one embodiment, the mobile phone 100 further includes a radio body 60 and defines at least one sound outlet 24. The radio body 60 is located on an end portion of the small plate 40. The at least one sound outlet 24 is defined in the upper housing 20. The upper housing 20 is provided with a second receiving cavity 22 for mounting a sound guide member 25. The sound guide member 25 is provided with a sound guide groove 251. A through hole (not labeled) is defined penetrating the small plate 40. One end of the through hole is located at a sound emitting end of the radio body 60, another end of the through hole communicates with one end of the sound guide groove 251, and another end of the sound guide groove 251 communicates with the sound outlet 24.

In one embodiment, the second receiving cavity 22 is used to receive the sound guide member 25, and the sound guide member 25 is provided with the sound guide groove 251. Specifically, the sound guide groove 251 is used to conduct the sound from the radio body 60 to the sound outlet 24.

In one embodiment, the mobile phone 100 further includes a second sealing member 70. One end of the second sealing member 70 is sealed to a portion of the upper housing 20 where the at least one sound outlet 24 is located, and another end of the second sealing member 70 is sealed to an end surface of the sound guide member 25 facing the at least one sound outlet 24.

In one embodiment, the mobile phone 100 further includes a third sealing member 80. One end of the third sealing member 80 is sealed to an end surface of the small plate 40 facing the sound guide member 25, and another end of the third sealing member 80 is sealed to an end surface of the sound guide member 25 facing the radio body 60.

By sealing the portion of the upper housing 20 where the sound outlet 24 is located and a position where the sound guide member 25 is coupled to the small plate 40, sound transmission through the sound guide groove 251 is improved. The sound transmission from the radio body 60 to the sound outlet 24 through the sound guide groove 251 further improves the sound effect of the speaker unit 30.

In one embodiment, the upper housing 20 is provided with a USB interface 26, and a fourth sealing member 261 is provided between the USB interface 26 and the upper housing 20. After the USB interface 26 is assembled to the upper housing 20, the fourth sealing member 261 is pressed between the upper housing 20 and the USB interface 26 to achieve a sealed connection between the USB interface 26 and the upper housing 20, which enhances an airtightness of the sound cavity and improves the sound effect of the speaker unit 30.

In one embodiment, the upper housing 20 is provided with a third receiving cavity 29, and the third receiving cavity 29 is separated from the first receiving cavity 21 by a partition 221. The partition 221 between the third receiving cavity 29 and the first receiving cavity 21 is provided with a guide cavity 27, and a cable plate 28 is passed through the guide cavity 27. A fifth sealing member 271 is provided between the upper housing 20 and the cable plate 28. After the cable plate 28 is passed through the guide cavity 27, the fifth sealing member 271 is pressed against the cable plate 28 to seal the guide cavity 27.

The fifth sealing member 271 sealing the guide cavity 27 enhances the airtightness of the sound cavity, thereby improving the sound effect of the speaker unit 30.

In one embodiment, the second sealing member 70, the third sealing member 80, the fourth sealing member 261, and the fifth sealing member 271 are a sealing foam or other sealing material that can achieve sealing.

In summary, the first sealing member 50 seals a connection between the upper housing 20 and the lower housing 10 to seal the first receiving cavity 21, thereby forming a complete sound cavity required for the sound of the speaker unit 30. No additional structures are required to form a sound cavity, which increases the volume of the sound cavity and improves the sealing of the sound cavity and the sound effect of the speaker unit 30. Furthermore, by coupling the upper housing 20 and the lower housing 10 together through the plurality of connecting portions, the stability of the connection between the upper housing 20 and the lower housing 10 is better. Finally, by sealing the position between the sound outlet 24 and the upper housing 20 and the position between the sound guide member 25 and the small plate 40, sound transmission from the radio body 60 to the sound outlet 24 through the sound guide groove 251 is improved, thereby improving the sound effect of the speaker unit 30.

In addition, no additional structures are required, which simplifies the assembly process and improves production efficiency and yield of the mobile phone 100.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

1. A mobile phone comprising:
a lower housing;
an upper housing, a first receiving cavity cooperatively formed between the lower housing and the upper housing;
a speaker unit arranged in the first receiving cavity;
a plate arranged in the first receiving cavity and electrically coupled to the speaker unit;
a first sealing member surrounding an inner wall of the first receiving cavity and sealing a connection between the upper housing and the lower housing; wherein:
the first receiving cavity serves as a sound cavity for the speaker unit;
a USB interface is provided on the upper housing;
a fourth sealing member is provided between the USB interface and the upper housing; and
the fourth sealing member is pressed between the upper housing and the USB interface to achieve a sealed connection between the USB interface and the upper housing.

2. The mobile phone of claim 1, wherein:
a stepped portion is provided on the upper housing; and
the speaker unit is arranged on the stepped portion and fixedly coupled to the upper housing.

3. The mobile phone of claim 2, wherein:
the speaker unit and the upper housing are bonded together by glue.

4. The mobile phone of claim 1, further comprising a radio body arranged on an end portion of the plate, wherein:
at least one sound outlet is defined in the upper housing;
the upper housing is provided with a second receiving cavity for mounting a sound guide member;
the sound guide member is provided with a sound guide groove; and
sound emitted by the radio body is transmitted through the plate, the sound guide groove, and the at least one sound outlet.

5. The mobile phone of claim 4, further comprising a second sealing member, wherein:
one end of the second sealing member is sealed to a portion of the upper housing where the at least one sound outlet is located, and another end of the second sealing member is sealed to an end surface of the sound guide member facing the at least one sound outlet.

6. The mobile phone of claim 5, further comprising a third sealing member, wherein:
one end of the third sealing member is sealed to an end surface of the plate facing the sound guide member, and another end of the third sealing member is sealed to an end surface of the sound guide member facing the radio body.

7. (canceled)

8. The mobile phone of claim 6, wherein:
the upper housing is provided with a third receiving cavity;
the third receiving cavity is separated from the first receiving cavity by a partition;
the partition between the third receiving cavity and the first receiving cavity is provided with a guide cavity;
a cable plate is passed through the guide cavity;
a fifth sealing member is provided between the upper housing and the cable plate; and
the fifth sealing member is pressed against the cable plate to seal the guide cavity.

9. The mobile phone of claim 1, wherein:
at least three first connecting portions are provided on an inner wall of the upper housing;
at least three second connecting portions are provided on the lower housing; and
the at least three first connecting portions clamp to the corresponding at least three second connecting portions.

10. The mobile phone of claim 1, wherein:
the first sealing member is a sealing foam.

11. A mobile phone comprising:
a lower housing;
an upper housing, a first receiving cavity cooperatively formed between the lower housing and the upper housing;
a speaker unit arranged in the first receiving cavity;
a plate arranged in the first receiving cavity and electrically coupled to the speaker unit;
a first sealing member surrounding an inner wall of the first receiving cavity and sealing a connection between the upper housing and the lower housing;
a radio body arranged on the plate; wherein:
at least one sound outlet is defined in the upper housing;
a sound guide member is provided on the upper housing and defines a sound guide groove; and
sound emitted by the radio body is transmitted through the plate, the sound guide groove, and the at least one sound outlet;
a USB interface is provided on the upper housing;
a fourth sealing member is provided between the USB interface and the upper housing; and
the fourth sealing member is pressed between the upper housing and the USB interface to achieve a sealed connection between the USB interface and the upper housing.

12. The mobile phone of claim 11, further comprising a second sealing member, wherein:
one end of the second sealing member is sealed to a portion of the upper housing where the at least one sound outlet is located, and another end of the second sealing member is sealed to an end surface of the sound guide member facing the at least one sound outlet.

13. The mobile phone of claim 12, further comprising a third sealing member, wherein:
one end of the third sealing member is sealed to an end surface of the plate facing the sound guide member, and another end of the third sealing member is sealed to an end surface of the sound guide member facing the radio body.

14. (canceled)
